(19) United States
(12) Patent Application Publication
(10) Pub. No.: US 2009/0300896 A1
(43) Pub. Date: Dec. 10, 2009

(54) Hub Bearing Assembly Removal Tool For Hub Bearing Assemblies

(76) Inventor: Salvatore Ozzimo, Perry, NY (US)

Correspondence Address: LAW OFFICE OF TRACY P. JONG, 2775 BUFFALO ROAD, SUITE 3, ROCHESTER, NY, 14624, US

(21) Appl. No.: 12/475,030

(22) Filed: May 29, 2009

Related U.S. Application Data
(60) Provisional application No. 61/058,788, filed on Jun. 4, 2008.

(51) Int. Cl. B23P 19/04

(52) U.S. Cl. 29/267

(57) ABSTRACT

The present invention is directed to a hub bearing assembly removal tool which expedites removal of the hub bearing assembly of wheels. In one embodiment, the hub bearing removal tool comprises an elongated member and a mounting flange having a series of apertures that receive the lug bolts of a hub bearing assembly. The tool facilitates removal of the hub bearing assembly by converting a downward hammer blow to a torque that effectively pries the hub bearing assembly from its seat.

### CROSS REFERENCE TO RELATED APPLICATONS AND PRIORITY CLAIM

This application claims the benefit of priority from U.S. Ser. No. 61/058,788 entitled “Hub Bearing Assembly Removal Tool” filed by Salvatore Ozzimo on Jun. 4, 2008.

### FIELD OF THE INVENTION

This invention relates to automotive repair tools and more particularly, to a novel tool designed to facilitate the removal of hub bearing assemblies.

### BACKGROUND

Many automobile suspension systems have an axle with a wheel hub disposed on each end of the axle. A bearing assembly is commonly disposed about the wheel hub and is used to support rotational movement of the wheels (and thus is commonly referred to as a wheel hub bearing assembly). Wheel hub bearing assemblies are subjected to severe stresses and wear. These stresses are mechanical as well as environmental and weather related. Wet climates in particular exacerbate corrosion on automotive parts. The accumulation of dirt, dust, moisture, and excessive loads carried on a vehicle, also contributes to seizure of wheel hub parts, and in particular, the corrosion of the hub bearing assembly in its seat.

Currently, there are few tools specifically designed for the removal of hub bearing assemblies on wheels. Likewise, there are few tools designed to readily remove a hub bearing assembly without having to remove other components associated with the suspension system (e.g., shocks, springs, controls arms, traction bars, and the like). Mechanics have resorted to blow torches, mallets, hammers, and slide hammers such as the ones disclosed in U.S. Pat. Nos. 5,991,994 and 6,971,149 to remove and break free the wheel hub bearing components that may be corroded and seized together. Other removal methods include the installation of longer bolts or studs from the rear of the assembly that operate to force apart the assembly from its seat. However, this method is generally ineffective for severely corroded parts for those disposed in complex axle locations.

Wheel hub bearing assemblies may be designed for both powered and non-powered wheels. Some have various component parts (e.g., the bearing) that are replaceable during the lifetime of the bearing assembly, while other bearing assemblies are generally removed and replaced with an entirely new wheel hub bearing assembly. The present invention is directed to hub bearing assemblies that are generally removed in their entirety for replacement.

What has been needed but as yet unavailable is a device that addresses some of the long-standing problems in the art. U.S. Pat. Nos. 5,991,994 and 6,971,149 are drawn to slide hammer devices. While these are useful in some aspects, they have an inherent drawback in that they rely on pulling forces to remove the bearing assembly. If a hammer blow were affected to the slide hammer, it would damage it and render the tool inoperable. Additionally, using a slide hammer requires a significant expenditure of time and energy by the mechanic for the many repetitions that are generally required in the process. As many mechanics appreciate, it is often preferable to apply a prying type force and/or the brut force of a hammer blow when removing severely corroded and seized parts. The force required may be more than 2500 pounds per square inch, a force slide hammers cannot provide.

It is desirable to design an automotive tool that improves upon prior art tools, improving upon their functionality and eliminating one or more of their limitations. The present invention fulfills this need and others.

### SUMMARY OF THE INVENTION

The present invention is therefore directed to a hub bearing assembly removal tool which expedites removal of the hub bearing assembly of wheels and overcomes the disadvantages commonly associated with other prior art tools. In accordance with the present invention, the preferred embodiment of a simplified hub bearing assembly removal tool is provided as well as two alternative embodiments. More specifically, in accordance with this invention, there is provided an improved hub bearing assembly removal tool that overcomes the limitations of the prior art by using a unique and previously unknown tool wherein the tool comprises an elongated member having a mounting flange, wherein the mounting flange comprises a series of apertures that are configured to receive a plurality of lug bolts of a hub bearing assembly. In one aspect, the mounting flange has a unique shape that enables it to universally mate with most hub bearing assemblies and easily traverse the tight spaces surrounding them in the wheel well. In another embodiment, the hub bearing assembly removal tool comprises an elongated member having a mounting bracket configured for attachment to a flange of a hub bearing assembly. Both embodiments facilitate removal of the hub bearing assembly by converting a downward hammer blow to a torque that effectively pries the hub bearing assembly from its seat. An elongated member is secured to a hub bearing assembly to provide sufficient leverage with which a torque may be applied in order to remove a hub bearing assembly from its seat.

A general object of the present invention is to provide a simple and low cost hub bearing assembly removal tool which expedites the removal of a worn hub bearing assembly without requiring excessive disassembly of the suspension system.

Another object of the present invention is to provide a hub bearing assembly removal tool which reduces the time and cost associated with the removal and replacement of a hub bearing assembly on a wheel.

It is a further object of the present invention to provide a hub bearing assembly removal tool that is versatile and readily adaptable to different hub bearing assemblies and automobiles.

Whereas there may be many embodiments of the present invention, each embodiment may meet one or more of the foregoing recited objects in any combination. It is not intended that each embodiment will necessarily meet each objective.

Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification. In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways. Also it is to be understood that the phraseology and terminology employed herein are for the purpose of description and should not be regarded as limiting.

### PARTICULAR ADVANTAGES OF THE INVENTION

The present invention discloses a novel bearing assembly removal tool having the advantage that is universal and may be adapted to hub bearing assemblies of various sizes, configurations and automotive manufacturers. The novel bearing assembly removal tool has no moving parts, requires no adapters, no power source, and is both safer and faster to use for hub bearing assembly removal than prior art tools such as slide hammers, air chisels, sledge hammers and gear pullers. The leverage applied by this novel tool advantageously operates in a peeling or prying fashion to dislodge the hub bearing assembly from its seat. A person is able to apply sufficient force, for example 8 pounds per square inch, by hand or with the aid of a simple hammer. The compact size (about a foot in length) allows the tool to be easily manipulated during use, as well as compactly stored when not in use.

The slot configuration and parallel orientation of the two lug bolt receiving apertures, and the need to be fitted over only two of the lug bolts during use, facilitates use of the tool with hub bolt assemblies having 4, 5, 6 or 8 lug bolts. At the engagement end is disposed a “U” shaped cutout in the flange with a 1.6 radius that is dimensioned to receive various hub bearing assembly necks that allows the tool to mate with hub bearing assemblies of various sizes, configurations and automotive manufacturers. This cutout, as well as the additional peripheral shape features of the flange, allows the tool to fit into almost any wheel area by adequately clearing adjacent component parts during installation and use of the tool. The novel shape of the flange offers a durable and strong tool for withstanding the forces placed on the tool during use, while minimizing the flange's footprint to reduce weight and materials costs. The elongated handle-like member provides sufficient leverage with which a torque may be applied in order to remove a hub bearing assembly from its seat.

Yet an additional advantage is offered in that the tool may also be used for leverage and stabilization of the suspension during strut work and suspension work.

### BRIEF DESCRIPTION OF THE DRAWINGS

The invention will be described by reference to the specification and the drawings, in which like numerals refer to like elements, and wherein:

FIG. 1 is a perspective view of a hub bearing assembly removal tool;

FIG. 2A is a side orthogonal view of the hub bearing assembly removal tool depicted in FIG. 1;

FIG. 2B is a rear orthogonal view of the hub bearing assembly removal tool depicted in FIG. 1;

FIG. 2C is a front orthogonal view of the hub bearing assembly removal tool depicted in FIG. 1;

FIG. 3 is a perspective view of the hub bearing assembly removal tool depicted in FIG. 1 as it is aligned for mounting on a hub bearing assembly;

FIG. 4 is a perspective view of the hub bearing assembly removal tool depicted in FIG. 1 as it is mounted on a hub bearing assembly;

FIG. 5 is a perspective view of the hub bearing assembly removal tool depicted in FIG. 1 as it removes a hub bearing assembly from an axle;

FIG. 6 is a perspective view of the hub bearing assembly removal tool depicted in FIG. 1 and a removed hub bearing assembly;

FIG. 7 is a perspective view of the hub bearing assembly removal tool depicted in FIG. 1 as it removes a hub bearing assembly of a different size and design from an axle;

FIG. 8 is a perspective view of an alternate embodiment of a hub bearing assembly removal tool;

FIG. 9A is a side orthogonal view of the hub bearing assembly removal tool depicted in FIG. 8;

FIG. 9B is a rear orthogonal view of the hub bearing assembly removal tool depicted in FIG. 8;

FIG. 9C is a front orthogonal view of the hub bearing assembly removal tool depicted in FIG. 8;

FIG. 10 is a perspective view of the hub bearing assembly removal tool of FIG. 8 as it is mounted to a hub bearing assembly;

FIG. 11 is a perspective view of an alternate embodiment of a hub bearing assembly removal tool in relation to a hub bearing assembly with 5 lug bolts;

FIG. 12 is a perspective view of the embodiment depicted in FIG. 11 in relation to a hub bearing assembly with 4 lug bolts;

FIG. 13A is an orthogonal view from the bottom of the embodiment depicted in FIG. 11;

FIG. 13B is an orthogonal view from the side of the embodiment depicted in FIG. 11; and

FIGS. 14A, 14B, 14C and 14D are cross sectional views of the embodiment depicted in FIG. 11 demonstrating how the novel shape of flange 104 is configured to work with 4, 5, 6 and 8 lug hole hub assembly configurations.

The drawings are not to scale, in fact, some aspects have been emphasized for a better illustration and understanding of the written description.

### PARTS LIST

2 hub bearing assembly removal tool

3 proximal end of tool

4 elongated member

5 engagement end of tool

6 flange

7 lower portion of the flange

8 is the bolt hole (aperture)

9 is the bolt hole (aperture)

10 bolt holders

12 mechanical fasteners (lug nuts)

13 apertures (slots)

14 thickness of the flange

15 central longitudinal axis of one series (set) of the bolt holes

16 length of the elongated member

17 central longitudinal axis of another series (set) of bolt holes

18 inner diameter of the elongated member

20 diameter of the flange

21 two 5-point bolt holes

23 two 4-point bolt holes

24 hub bearing assembly

25 flange of the hub bearing assembly

26 lug bolts

26a, 26b lug bolts that are used to engage the tool

26c, 26d lug bolts that are not engaged to the tool

27 direction of the force applied to the proximal end

28 neck

28a neck diameter

30 mounting plate

32 knuckle

34 mounting plate

36 interface between mounting plate of knuckle and mounting plate of hub bearing

38 mechanical fasteners

53 hub bearing assembly

62 hub bearing assembly removal tool

63 mounting bracket structure

64 rectangular or bar-shaped elongated member

66 L-shaped member

68 retaining member

70 removable foot members

72 inboard side wall

74 contacting surface of foot member

76 distance of opening

78 distance

80 depth

82 length of elongated member

83 width of elongated member

84 depth of elongated member

85 depth of L-shaped member

86 width of retaining member

87 width of L-shaped member

88 depth of retaining member

92 cavity

94 depth of foot members

96 distance between 2 foot members

98 width of foot members

100 hub bearing assembly removal tool

102 elongated slot apertures

102a left elongated slot apertures

102b right elongated slot apertures

104 flange concave cutout

106 side wall

106a inner left edge of triangular support

106b inner right edge of triangular support

108 triangular support or triangular portion

108a left triangular support or triangular portion

108b right triangular support or triangular portion

109a outer left edge

109b outer right edge

110 elongated member

112 elongated slot width

114 distance of elongated slot length

116 distance to adjacent lug bolt

118 angle

120 distance

122 distance

124a mounting flange lower flange

126 distance

128 distance

130 angle

142 distance

### DETAILED DESCRIPTION OF A PREFERRED EMBODIMENT OF THE INVENTION

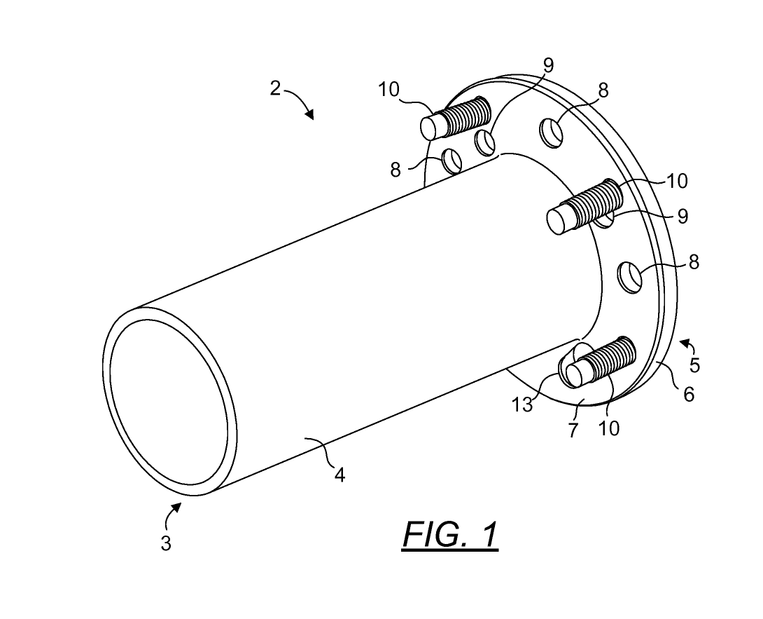

FIG. 1 is a perspective view of a preferred embodiment of a hub bearing assembly removal tool 2 (“tool”) of the present invention. Referring to FIG. 1, the hub bearing assembly removal tool 2 preferably comprises one-piece construction including an elongated member 4 having a proximal end 3, an engagement end 5, and a flange 6 having a plurality of spaced apertures 8, 9, 13 adapted to receive similarly spaced lug bolts. The flange 6 is so formed integrally therewith as to extend radially outwardly from an engagement end of the tool 2, and provides a means through which the tool 2 can be secured to a vehicle's hub bearing assembly. An elongated member 4 is secured to a hub bearing assembly 24 to provide sufficient leverage with which a torque may be applied in order to remove a hub bearing assembly 24 from its seat.

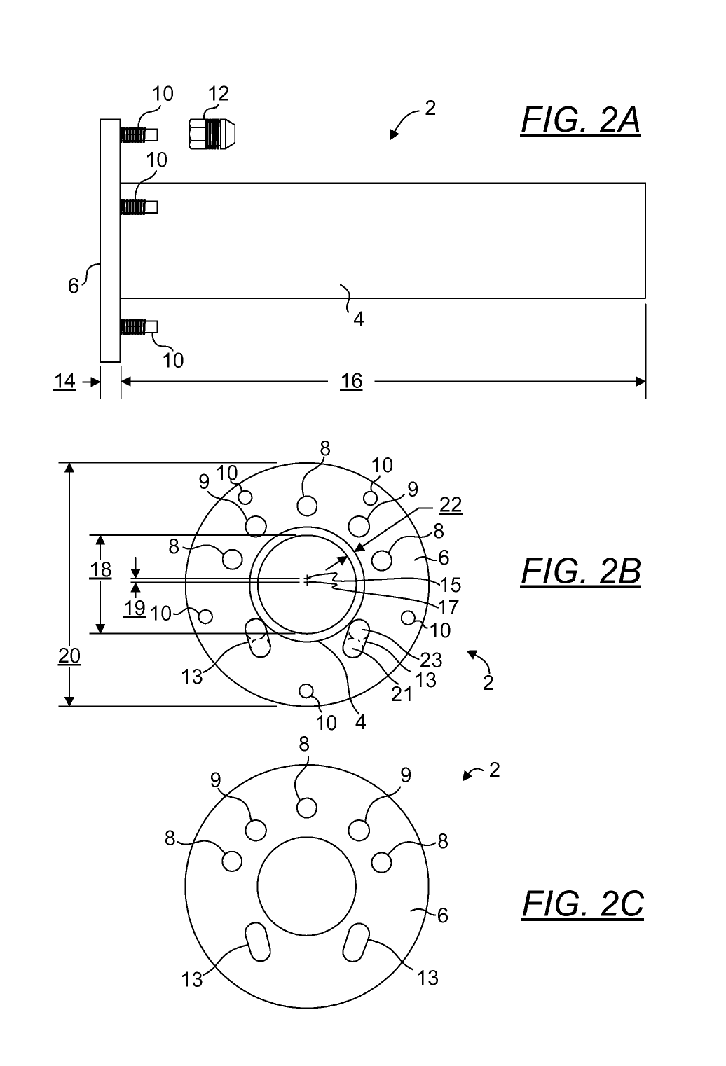

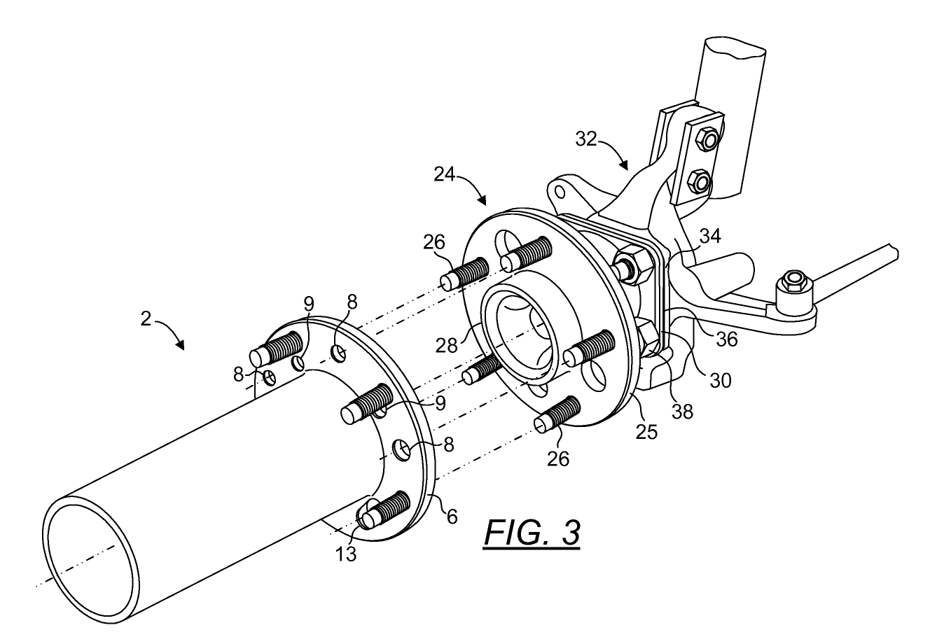

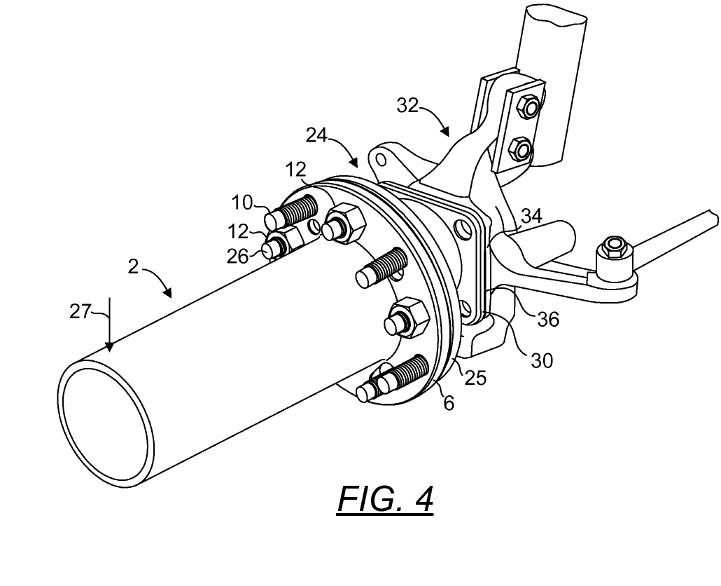

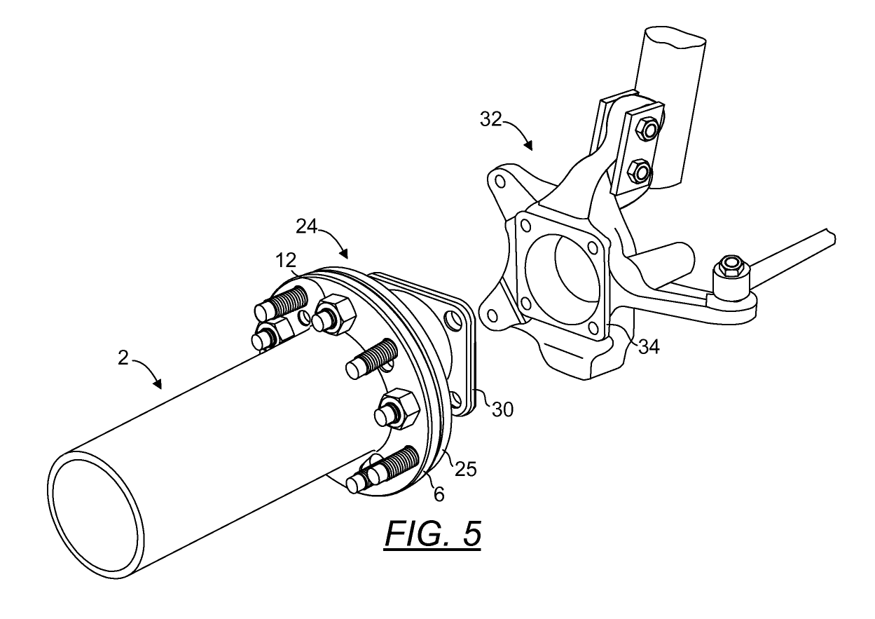

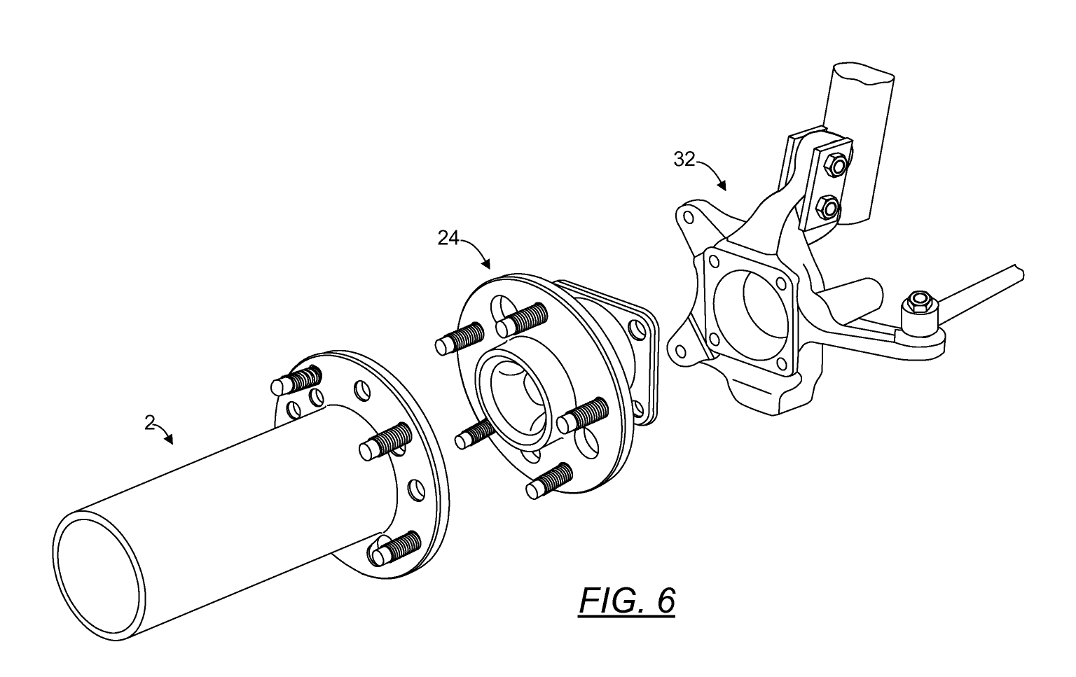

FIG. 2A is a side orthogonal view of one embodiment of a tool 2, FIG. 2B is a rear orthogonal view of the embodiment 2, and FIG. 2C is a front orthogonal view of the embodiment 2. FIG. 3 is a perspective view of the tool 2 as it is aligned for mounting on a hub bearing assembly. FIG. 4 is a perspective view of the tool 2 as it is mounted on a hub bearing assembly. FIG. 5 is a perspective view of the tool 2 as it removes a hub bearing assembly from its seat. FIG. 6 is a perspective view of the tool 2 and removed hub bearing assembly.

Referring to FIG. 3, a hub bearing assembly 24 is secured to a knuckle 32 by means of mechanical fasteners 38. Seizure of the wheel hub parts typically occurs at the interface 36 between the mounting plate 30 of the hub bearing 24 and the mounting plate 34 of the knuckle 32. Seizure also occurs between the hub bearing assembly and its seat. Mechanical fasteners 38 are removed as shown in FIG. 4 prior to attempts to remove the hub bearing assembly 24 from the seat 32.

Referring to FIGS. 3, 4, 5 and 6, the tool 2 is preferably used by axially aligning the apertures 8, 9, 13 of the flange 6 with the hub bearing assembly's lug bolts 26 and then inserting at least a portion of a lug bolt 26 into at least one of, and preferably at least two of, the bolt holes 8, 9 of the flange 6 and securing the lug bolt 26 therein using mechanical fasteners 12. A force is then applied in direction 27 to the proximal end 3 of the elongated member 4 until the hub bearing assembly 24 is disengaged from its seat. In one aspect, the aspect, the tool 2 exerts a force of from about 2500 to about 3000 pounds per square inch on the hub bearing assembly to break away or remove the hub bearing assembly from its seat.

In some uses, all of the lug bolts 26 of the hub bearing assembly 24 are secured in the corresponding bolts holes 8, 9 and slots 13. Since force is applied from a single direction 27 in most cases (e.g. downward hammer blows), it is necessary only to secure the upper two or three lug bolts 26 in the upper bolt holes 8, 9 to prevent the tool 2 from disengaging from the hub bearing assembly 24 during use. (As will be apparent, if force is desired in another direction, the hub bearing assembly may simply be rotated.) The downward hammer blows urge the lower portion 7 of the tool's 2 flange 6 against the flange 25 of the hub bearing assembly 24, thus making it unlikely for the lug bolts 26 disposed in the slots 13 of the lower portion 7 of the flange 6 to disengage. Thus, securing the lug bolts 26 disposed in slots 13 with lug nuts 12 is not necessary in every application.

Preferably, the mechanical fasteners are the lug nuts 12 from the hub bearing assembly 24. As will be apparent to those skilled in the art, many mechanical fastener arrangements may be suitably adapted to satisfy the intended function of this structural component.

Each of the mechanical fasteners 12 is rotated until the external threads of the lug bolt 26 engage the internal threads of the lug nut (mechanical fastener) 12. The lug bolt 26 and lug nut mechanical fasteners 12 cooperate to retain the tool 2 on the hub bearing assembly 24 and to restrict relative displacement between the tool 2 and the hub bearing assembly 24. After the tool 2 has been removably affixed to the hub bearing assembly 24, a force is applied to the relative displacement between the tool 2 and the hub bearing assembly 24 elongated member 4, such as, for example, by a downward hammer blow to the proximal end 3 of the tool 2. As a downward 27 force is applied to the proximal end 3 of the elongated member 4, the lower portion 7 of the flange is urged against the hub bearing assembly 24, creating a torque that effectively pries it away from its seat.

In one aspect depicted in FIGS. 1-7, the flange 6 comprises a circular or ring shaped body, however, the invention is not so limited. A square or any other regular or irregular shaped flange 6 may be suitably used. The flange 6 is configured and shaped so as to provide adequate support for a plurality of apertures 8, 9 and to conform so as to provide contacting engagement with the hub bearing assembly 24. In the embodiment depicted, the flange 6 is configured and shaped so as to contain two series of apertures 8,9 (each set also includes slots 13) such that each series corresponds to a specific size and configuration of hub bearing assembly 24. In another embodiment (not depicted), the apertures 8,9,13 are adjustable so as to conform to the location of the lug bolts 26 on a variety of hub bearing assemblies 24.

In the embodiment depicted in FIGS. 1, 2A, 2B and 2C, the apertures comprise three 5-point bolt holes 8, two 4-point bolt holes 9 and two slots 13. The 5-point bolt hole series apertures 8, 13 correspond to the lug bolts on hub bearing assemblies having 5 lug bolts and the 4-point bolt hole series apertures 9, 13 correspond to the lug bolts on hub bearing assemblies having 4 lug bolts. The three 5-point bolt holes 8 and two slots 13 are spaced radially and angularly an equal distance from each other around the flange 6 and adapted to receive similarly spaced lug bolts. Similarly, the two four-point bolt holes 9 and two slots 13 are spaced an equal distance from each other around the flange 6 and adapted to receive similarly spaced lug bolts. As may be more clearly seen with reference to the drawings, the three 5-point bolt holes 8 are alternating with the two 4-point bolt holes 9 on an upper portion of the flange 6. On the lower portion 7 of the flange 6, the two slots 13 substitute for the corresponding bolts holes 8, 9 in the five-point bolt configuration and 4-point bolt configuration.

In another embodiment (not depicted), a single set of bolt holes 8, 9 or slots 13 is provided. The bolts holes or slots are spaced radially and angularly an equal distance from each other around the flange 6 and adapted to receive similarly spaced lug bolts. In one aspect, the single set may comprise 5-point bolt holes 8, 4-point bolt holes 9, slots 13, or the like. The bolt holes 8, 9 have a diameter sufficient to receive the lug bolts 26. In another embodiment (not depicted), a plurality of aperture series 8, 9 are provided,

In one embodiment depicted in the drawings, the tool 2 further comprises a plurality of bolt holders 10 embedded in the flange 6 and so formed integrally therewith as to extend from the flange 6. The bolt holders 10 are generally cylindrical shaped externally threaded members and spaced radially and angularly an equal distance from each other around the flange 6, alternating with a plurality of bolt holes 8 (see also FIGS. 2B and 2C). Preferably, a plurality of bolt holders 10 are equally spaced about the flange 6 as depicted in FIG. 2B. While the number of bolt holders 10 may vary in different embodiments, in the embodiment depicted in FIG. 2B, there are five bolt holders 10. In another embodiment, there are four bolt holders 10. In one embodiment depicted, the bolt holders 10 have an exterior diameter corresponding to the lug bolts 26 on the hub bearing assembly 24 such that they are sized and configured to receive the lug nuts of the hub bearing assembly 24. These function as a place to rest or store the lug nuts 12 when not in use.

Referring to FIG. 2A, the thickness 14 of the flange 6 is from about 0.25 inch to about 1.0 inch, preferably about 0.5 inch. Elongated member 4 has a length 16 of from about 3 inches to about 20 inches, preferably about 15 inches. Referring again to FIG. 2B, the diameter 20 of the flange 6 is preferably from about 5 inches to about 7 inches, preferably about 6 inches. Preferably, at least a portion of the tool's flange 6 contacts the flange 25 of the hub bearing assembly 24 when assembled for use, and even more preferably, at least 50% of the surfaces of each respective component 6, 13 is in contacting engagement when assembled for use.

Referring to FIGS. 2B and 3, the inner diameter 18 of the elongated member 4 at the engagement end 5 is dimensioned to receive the neck 28 of a hub bearing assembly 24. The inner diameter of the opening of the elongated member 4 is preferably about ⅛ inch larger than the outer diameter of a neck 28 of a hub bearing assembly 24. In certain hub bearing assemblies, the neck 28 is about 2 and 3/16 inches, and in another model, it is about 2 and ¾ inches. Thus, the inner diameter 18 of the opening of the elongated member 4 at the engagement end 5 is preferably about 2, and about 5/16 inches and 2 and ⅞ inches, respectively. In one embodiment, the inner diameter 18 of the elongated member 4 is from about 2 inches to about 4 inches, preferably from about 2 and 5/16 inches to about 3 inches, and the outer diameter of the elongated member 4 is from about 3 inches to about 4 inches, preferably from about 3 inches to about 3 and ¼ inches.

FIG. 3 depicts the tool 2 as it is aligned to be installed on a hub bearing assembly 24 of an automobile. By way of illustration, but not limitation, these hub bearing assemblies 24 are found on rear wheel hub bearing assemblies on vehicles such as General Motors front wheel drive vehicles manufactured after 1990. It may also be suitably used with rear wheel hub bearing assemblies used in 1993-2002 Toyota Corollas, 1993-1997 Geo Prizms and 1998-2002 Chevy Prizms.

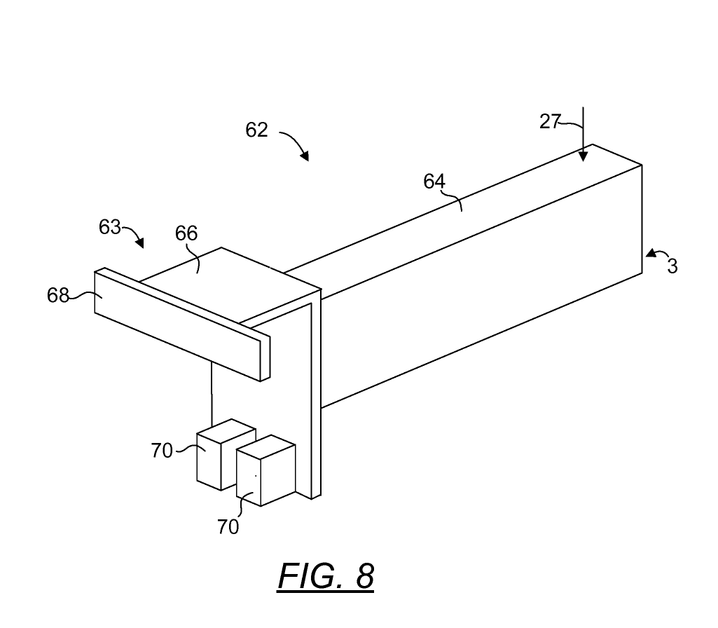

In one embodiment, the elongated member 4 has a circular cross-sectional shape; however, the present invention is not so limited. Rather, the peripheral shape of the elongated member 4 may take any shape or form. The elongated member 4 preferably has a bore extending therethrough to reduce the weight. The shape of the bore through the elongated member 4 is not limited to having a uniform diameter. More specifically, the elongated member in FIGS. 1-7 is cylindrical; however, the elongated member may also be rectangular as depicted in FIGS. 8-10 or any other desirable shape. In one preferred embodiment, the elongated member 4 is hollowed to reduce the weight of the tool 2 and make it easier to use. In one aspect, the interior profile of the elongated member 4 is not uniform in that the thickness of the wall is greater at the proximal end 3 than at the engagement end 5 to add weight to the proximal end 3.

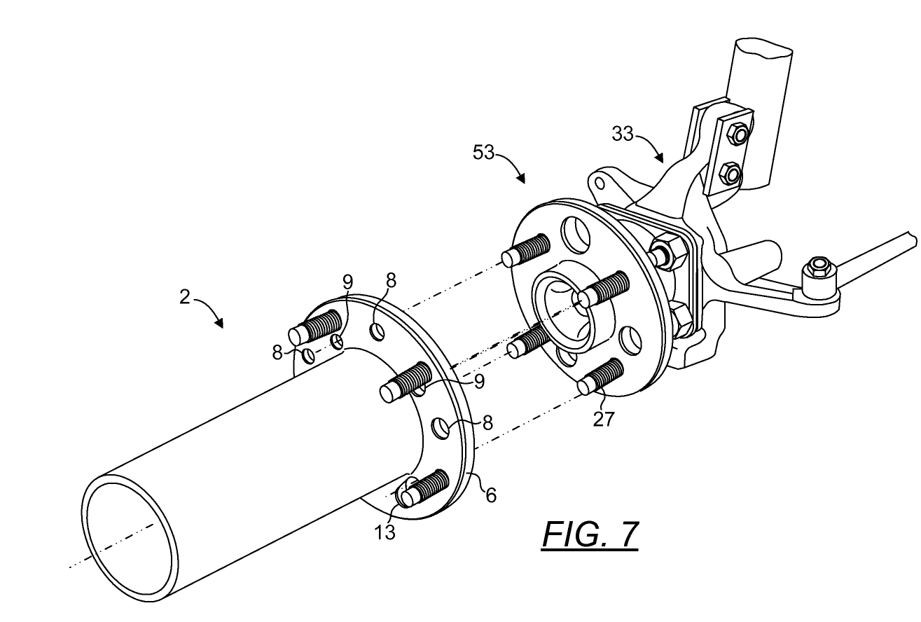

FIG. 7 is a perspective view of a tool 2 as it is secured to a hub bearing assembly 53 of a different size and design. As may be seen more clearly with reference to FIG. 7, the lug bolts 26 are secured in the four-point bolt holes 9 and slots 13.

As will apparent, the embodiment depicted in FIGS. 8-10 is substantially the same as depicted and described with respect to tool 2 (see, for example, FIGS. 1-7) with the exception of the claw-like mounting bracket used to secure the tool 62 to the hub bearing assembly 53. The mounting bracket is sized, aligned and configured to receive and secure a flange 25 of the hub bearing assembly 53 therein.

As will be appreciated, these embodiments 2, 62 are intended to be illustrative and nonlimiting, and that many means of securing the tool 2, 62 to a hub bearing assembly 53 may suitably be adapted to accomplish the intended function and are to be regarded as included within the scope of the present invention.

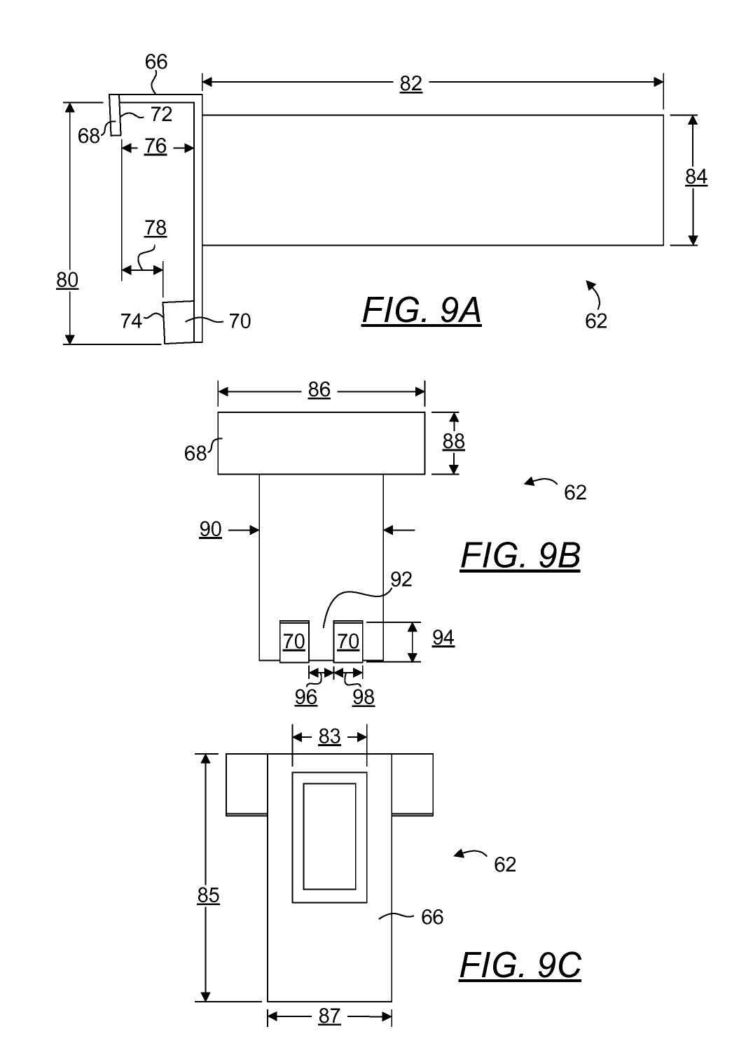

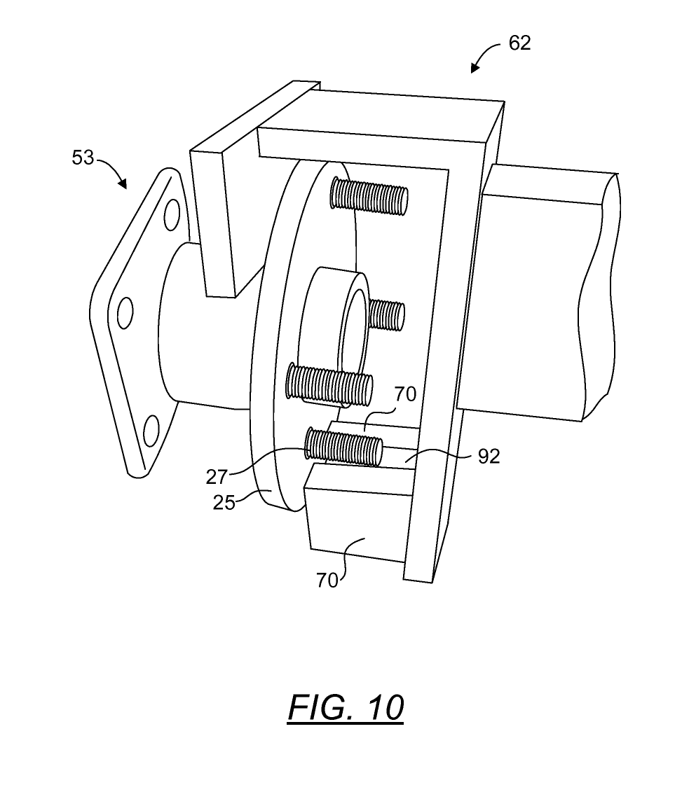

FIG. 8 is a perspective view of an alternate embodiment of a hub bearing assembly removal tool 62 (“tool”). FIG. 9A is a side orthogonal view of the embodiment of tool 62 depicted in FIG. 8. FIG. 9B is a rear orthogonal view the embodiment of tool 62 depicted in FIG. 8. FIG. 9C is a front orthogonal view the embodiment of tool 62 depicted in FIG. 8. FIG. 10 is a perspective view of the embodiment of the tool 62 depicted in FIG. 8 as it is mounted to a hub bearing assembly 53.

In the embodiment of the tool 62 depicted in FIGS. 8-10, the cylindrical elongated member 4 of the embodiment depicted in FIGS. 1-7 is replaced with a rectangular or bar-shaped elongated member 64. Additionally, the means of attaching the elongated member 64 to the hub bearing assembly 53 differs in that it comprises a claw-like mounting bracket structure 63. A force applied in a downward direction 27 operates to apply a torque that disengages the hub bearing assembly 53 from its seat.

Referring to FIGS. 8-10, the mounting bracket 63 comprises an L-shaped member 66, a retaining member 68, and one or more removable foot members 70. The mounting bracket is dimensioned and sized to removably affix the tool 62 to a wheel bearing assembly 53 of a vehicle. When used, the retaining member 68 functions to secure the tool 62 about the flange 25 of a hub bearing assembly 53. As a torque is applied by a hammer blow exerted on the proximal end 3 of the elongated member 64, the foot member 70 exerts a pushing force on the hub bearing assembly 53 such that a torque is created and the hub bearing assembly 53 is pried from its seat.

In one aspect of this embodiment 62, the retaining member 68 is adjustable and/or removable. In one aspect of this embodiment 62, the foot member 70 is magnetically adjustable and/or removable. These adjustable and/or removable parts allow for a plurality of components designed to fit various wheel hub sizes and configurations of hub bearing assemblies.

Referring to FIGS. 9A and 9B, the elongated member 64 has a length 82 of from about 3 inches to about 20 inches, preferably about 15 inches, and a depth 84 of from about 1 inch to about 8 inches, preferably about 3 inches to about 4 inches, and a width 83 of from about 1 inch to about 8 inches, preferably about 2 inches to about 3 inches.

Referring to FIGS. 9A and 10, the opening of the mounting bracket 63 is dimensioned to receive the flange 25 of the hub bearing assembly 53 and preferably extends a distance 76 of from about 0.5 to about four inches, preferably about 2⅜ inch. The thickness of the mounting bracket 63 is from about 5/32- 9/32 inches. The mounting bracket 63 opening is preferably from about 1/16 inch to about ⅛ inch greater than the profile of the hub bearing assembly.

Referring to FIGS. 9A, 9B and 10, the depth 80 of the mounting bracket 63 is dimensioned to receive the flange 25 of the wheel hub bearing assembly 53 in a manner that the lug bolts 27 are in contacting engagement with the foot member 70 when the tool 62 is in use. In one aspect, the depth 80 of the mounting bracket 63 is from about 0.5 to about 6.5 inches, preferably about 5-6 inches. The foot members 70 have a depth 94 of from about 0.25 to about 2 inches, preferably about 1 and 3/16 inches, and a width 98 of from about 0.25 to about 1.5 inches, preferably about 11/16 inch. Two foot members 70 are spaced a distance 96 of from about 1/16 inch to about ¾ inch, preferably about ½ inch to 9/16 inch, from one another such that the cavity 92 is dimensioned to receive a lug bolt 27.

Referring to FIG. 9C, the L-shaped member 66 has a depth 85 of from about 0.5 to about 6.5 inches, preferably about 5-6 inches and the width 87 is from about 2 to about 6 inches, preferably about 3 inches. The retaining member 68 comprises a rectangular portion having a width 86 of from about 1 inch to about 4 inches, and a depth 88 of from about 2 inches to about 7 inches, preferably about 5 inches. The retaining member 68 is preferably biased inwardly toward the elongated member 64 to secure the mounting bracket 63 to the hub bearing assembly 53. In a similar fashion, the contacting surface 74 of foot member 70 is parallel with the inboard side wall 72 of the retaining member 68. The contacting surface 74 of foot member 70 is disposed a distance 78 of equivalent to the depth of the hub bearing assembly at its deepest point (in one aspect ⅜ inch) from the inboard side wall 72 of retaining member 68.

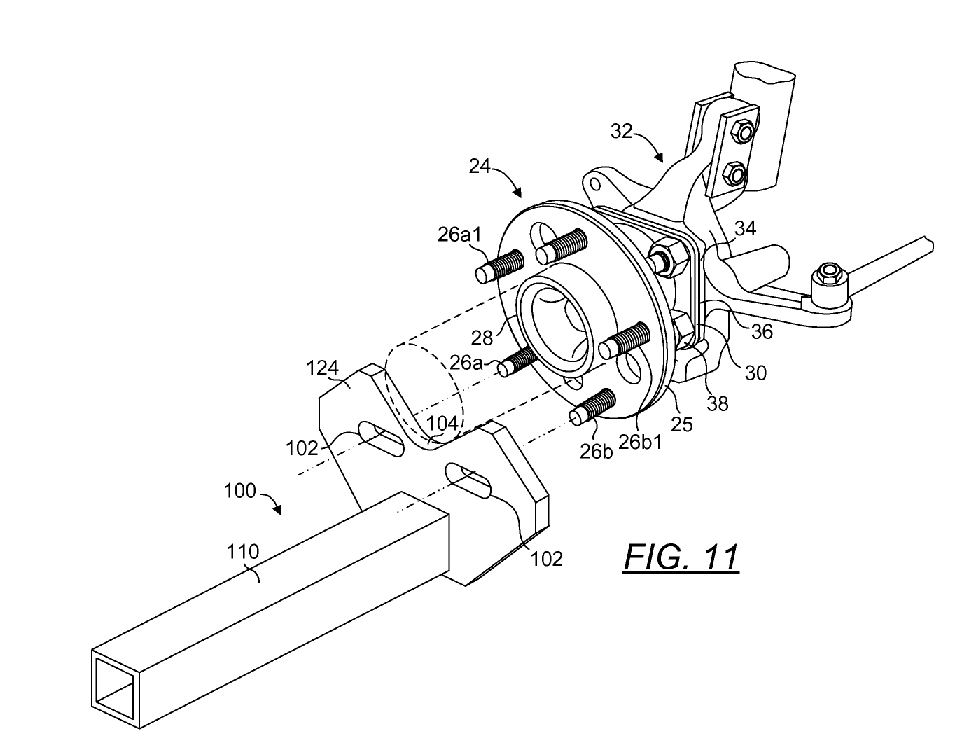

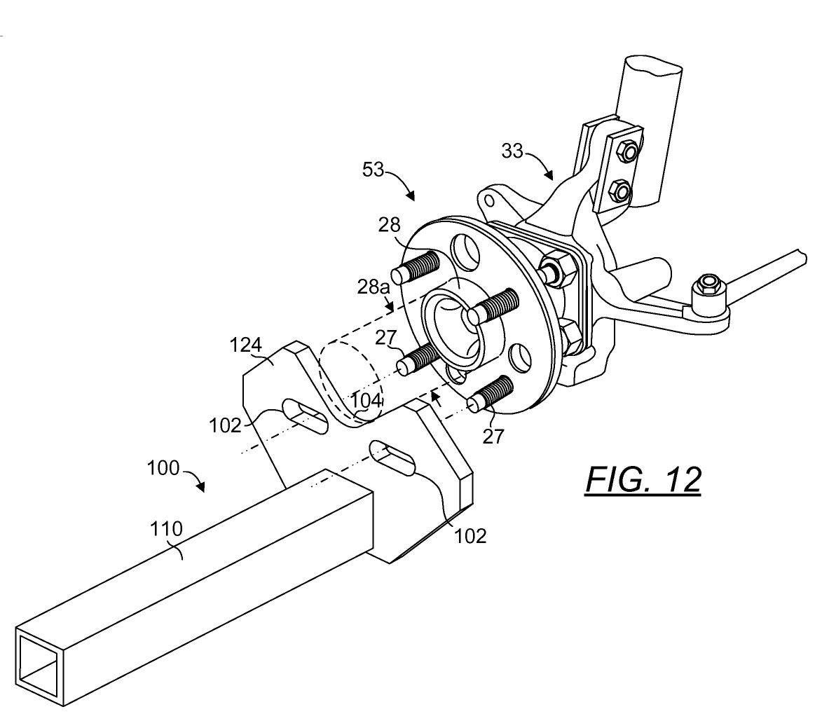

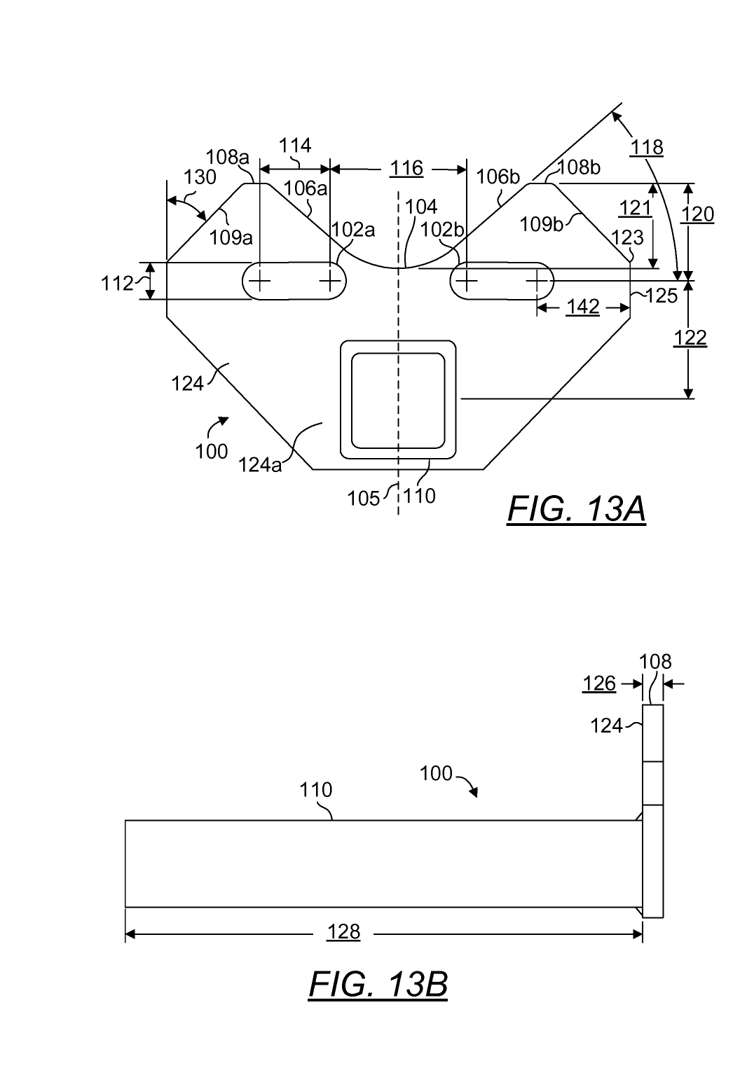

FIG. 11 is a perspective view of an alternate embodiment of a hub bearing assembly removal tool in relation to a hub bearing assembly with 5 lug bolts and FIG. 12 is a perspective view of the embodiment depicted in FIG. 11 in relation to a hub bearing assembly with 4 lug bolts. FIG. 13A is an orthogonal view from the bottom of the embodiment depicted in FIG. 11 and FIG. 13B is an orthogonal view from the side of the embodiment depicted in FIG. 11. Referring to FIGS. 11-13, this embodiment is similar to the embodiment 2 depicted in FIG. 1 but improves upon the design of the mounting flange 124.

The hub bearing assembly removal tool 100 preferably comprises one-piece construction including an elongated member 110. The tool 100 is substantially symmetrical about centerline 105. The flange 124 has two elongated apertures 102 adapted to receive similarly spaced lug bolts. The flange 124 is so formed integrally therewith as to extend radially outwardly from the engagement end of the tool 100, and provides a means through which the tool 100 can be secured to a vehicle's hub bearing assembly. An elongated member 110 is secured to a hub bearing assembly 24 to provide sufficient leverage with which a torque may be applied in order to remove a hub bearing assembly 24 from its seat.

The tool 100 is preferably used by axially aligning the slot bolt hole apertures 102 of the flange 124 with the hub bearing assembly's lug bolts 26 and then inserting at least a portion of a lug bolt 26 into at least one of, and preferably both of, the apertures 102 of the flange 124 and securing the lug bolt 26 therein using mechanical fasteners. A force is then applied in a downward direction to the proximal end of the elongated member 110 until the hub bearing assembly 24 is disengaged from its seat.

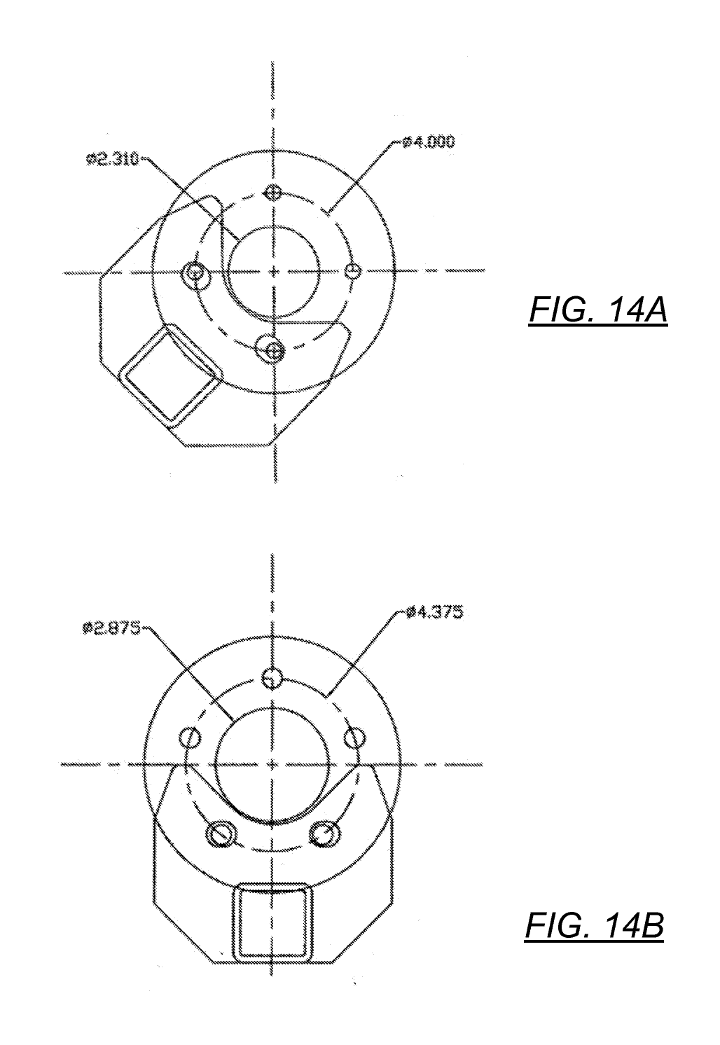

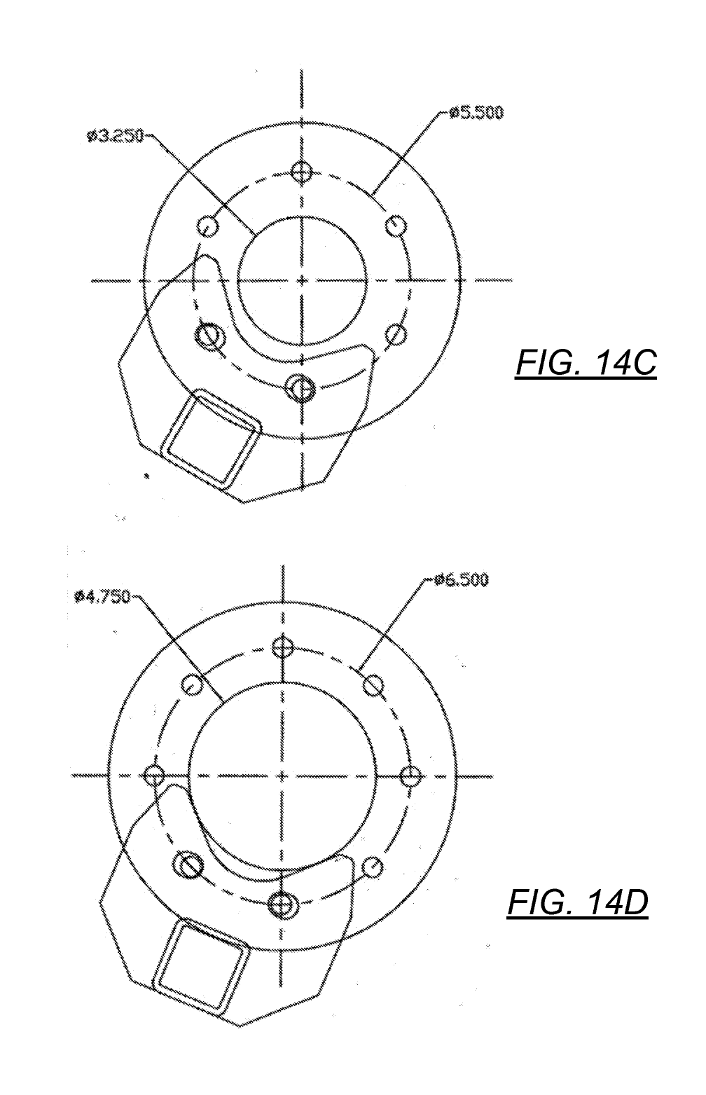

The slot configuration and parallel orientation of the two lug bolt receiving apertures, and the need to be fitted over only two of the lug bolts 26 during use, facilitates use of the tool with hub bolt assemblies having 4, 5, 6 or 8 lug bolts 26. At the engagement end is disposed a concave (e.g., a “U” or rounded “V” shaped) cutout 104 in the flange 124, preferably with a 1.6 inch radius, that is dimensioned to receive various hub bearing assembly necks 28 that allows the tool 100 to mate with hub bearing assemblies of various sizes, configurations and automotive manufacturers. FIGS. 14A, 14B, 14C and 14D are cross sectional views of the embodiment depicted in FIG. 11 demonstrating how the novel shape of flange 104 is configured to work with 4 (FIG. 14A), 5 (FIG. 14B), 6 (FIG. 14C), and 8 (FIG. 14D) lug hole hub assembly configurations. For example:

| | | | | |
|---|---|---|---|---|
| 6 lug | 5.5 | BC | 3.25 | inch hub |
| 4 lug | 4.0 | BC | 2.3 | inch hub |
| 8 lug | 6.5 | BC | 4.75 | inch hub |
| 5 lug | 4.375.5 | BC | 2.875 | inch hub |

The design may also be used with other configurations and it should be understood that these examples are not to be considered limiting, but rather, exemplary in nature.

Side wall 106 of the cutout 104 forms angle 118 with a line running parallel with the bottom edge that is preferably about 45 degrees. This cutout 104, as well as the additional peripheral shape features of the flange 124, allows the tool to fit into almost any wheel area by adequately clearing adjacent component parts during installation and use of the tool 100.

Two flat (or gently rounded) triangular portions 108 on the top of the flange 124 facilitate good contact and leverage during use, minimizing slippage and enhancing the peeling or prying action of the tool 100. The triangular shape allows the flange 124 to be used with various lug bolt configurations described above without interference from other nonengaged lug bolts. The triangular shape is identical on both the top left and top right portions and is formed with angle 130 (about 45 degrees) and angle 118 (also about 45 degrees). The axis along the upper edge of the elongated slots (the side closest to the cutout) intersects the perpendicular axis running along the side edges of the flange at a point that begins the incline for the outer walls of the triangular portions. The center of cutout 104 is formed with a radius of 1.6 inches. Interior triangular wall 106 tangents the radius and inclines at an angle of 45 degrees.

In one aspect depicted in FIGS. 11-14, the flange 124 comprises a 10 sided asymmetrical polygon in the form of an angular kidney bean-like shape with general dimensions of about 8 inches in length (as measured left to right sides) and 5 inches in width (as measured top to bottom sides) at the longest and widest points respectively.

The novel shape of the flange 124 offers a durable and strong tool 100 for withstanding the forces placed on the tool 100 during use, while minimizing the flange's 104 footprint to reduce weight and materials costs. This novel 10 sided polygon shape provides the advantage that is universal and may be adapted to hub bearing assemblies of various sizes, configurations and automotive manufacturers. It is to be understood that a more rounded shape may be used, as well other shapes that allow the flange to fit in the space surrounding a hub bearing assembly.

For clarity's sake, clear means free from interference that would prevent successful engagement of the tool to a hub bearing assembly. For example, a lug bolt or neck that prevents proper attachment of the flange to the hub bearing assembly.

Referring to FIG. 13A, distance 122 is from about 2 inches to about 3 inches, preferably about 2.3 inches. Distance 120 is preferably 1.67 inches. Distance 116 is from about 2 to about 3 inches, preferably about 1.8 inches. Distance 114 is from about 1 to about 2 inches preferably about 1.2 inches. The elongated apertures 102 are formed by joining two circular cutouts, an interior and an exterior circle, each having a diameter of 0.625 inches (about ⅝ inch). (The interior circles are closest to the centerpoint of the flange). Distance 142 is preferably about 1.6 to 1.7 inches.

The elongated handle-like member 110 has a 2 inch by 2 inch square cross section and walls with a thickness of 0.25 inch. This durable configuration provides sufficient leverage with which a torque may be applied in order to remove a hub bearing assembly from its seat. Referring to FIG. 13B, distance 128 is from about 3 to about 36, preferably from about 4 to about 18 inches, and most preferably from about 12 to about 14 inches. Distance 126 is from about 0.25 inch to about 1 inch, preferably from about 0.25 to about 0.75 inch, most preferably 0.5 inch.

As will be readily apparent, the novel bearing assembly removal tool has no moving parts, requires no adapters, no power source, and is both safer and faster to use for hub bearing assembly removal than prior art tools such as slide hammers, air chisels, sledge hammers and gear pullers. The leverage applied by this novel tool advantageously operates in a peeling or prying fashion to dislodge the hub bearing assembly from its seat. A person is able to apply sufficient force, for example as little as 8 pounds per square inch, by hand or with the aid of a simple hammer. The compact size (about a foot in length in the embodiment disclosed and described with respect to FIGS. 11-14) allows the tool to be easily manipulated during use, as well as compactly stored when not in use.

A hub bearing assembly removal tool comprising an elongated member having a mounting flange wherein the mounting flange is disposed at a first end of the elongated member and is outwardly protruding therefrom, and comprises two apertures that are configured to receive two lug bolts of a hub bearing assembly, and when the hub bearing assembly tool is secured to the hub bearing assembly with one or more mechanical fasteners, the elongated member provides sufficient leverage and converts a downward force to a torque sufficient to pry the hub bearing assembly from its seat. The centerpoint of the first elongated aperture and the centerpoint of the second elongated aperture are disposed at a distance of from 2.3 to 2.8 inches apart. The two apertures are disposed and configured to receive two lug bolts of a standard 4 lug bolt hub assembly for a 2.3 inch hub, and a standard 6 lug bolt hub assembly for a 3.25 inch hub, and a standard 8 lug bolt hub assembly for a 4.75 inch hub, and a standard 5 lug bolt hub assembly for a 2.875 inch hub. The mounting flange further comprises a concave cutout having radial circumference of 1.6 inches at a centerpoint of the cutout along a peripheral edge of the concave wall.

Preferably, the mounting flange 124 has an elongated member 110 perpendicularly attached to a lower portion of the mounting flange as well as a pair of projecting (depicted in this embodiment 100 as triangular) supports 108a, 108b symmetrically located about a centerline 105 of the tool 100 (it is to be appreciated that the triangular supports may also be semicircular or even other geometric or nongeometric shapes.) The left triangular support 108a has an inner left edge 106a and the right triangular support 108b has an inner right edge 106b. The inner left edge 106a and the inner right edge 106b are connected via a concave cutout 104 having radial circumference of 1.6 inches at a centerpoint of the cutout along a peripheral edge of its concave wall.

There is also provided a pair of slots comprising a left slot 102a and a right slot 102b each disposed below the left triangular support 108a and right triangular support 108b respectively, the left 102a and right 102b slots each having an elongated slot width 112 adapted to receive a lug bolt of a mounting bolt pair, and an elongated slot length 114 adapted to receive a plurality of hub bolt configurations of a hub bolt assembly. Placement of the pair of slots 102a, 102b, the concave cutout 104, and the outer left edge 109a and the outer right edge 109b are configured such that the mounting flange does not receive interference from a neck 28 of a hub bolt assembly, and the right outer edge 109b and the left outer edge 109a clear a plurality of nonengaged lug bolts 26c, 26d when the pair of slots are affixed to a mounting bolt pair 26a, 26b.

Yet an additional advantage is offered in that the tool 100 may also be used for leverage and stabilization of the suspension during strut work and suspension work.

### Materials and Manufacturing

The tool may be formed of a rigid metal or high strength plastic. By way of illustration, but not limitation, steel, carbon steel, soft iron, an aluminum alloy, aluminum bronze, stainless steel, brass, aluminum or fiber reinforced plastic may be used. It may also be formed of high strength aluminum, stainless steel or other high strength metals and metal alloys. In one embodiment, the tool 2, 62 is preferably composed of a rust resistant and light weight material.

The present invention is manufactured according to any method known to, or devised by, one skilled in the art for the manufacture of automotive tools. For ease of manufacturing, access to the bore of the elongated member 4 may be desirable. To accomplish this, the tool 2 may be manufactured as an integral unit, or alternatively, tool 2 may be manufactured as one or more separate components and assembled together to form a tool 2. By way of illustration, flange 6 may be manufactured as a separate component and elongated member 4 may be manufactured as a separate component. The elongated member may be manufactured as two or more component parts, for example, one component being a removable or replaceable extension sleeve.

The tool 2 is also not limited to being a unitary device. The present invention encompasses, among other embodiments, embodiments in which the tool 2 may be formed or fabricated from separate component parts (e. flange 6, elongated member 4, and bolt holder 10). The unitary construction is preferred because it may prevent mechanical failure at weak points where components are joined. Where significant forces may be applied to the tool 2 during use, this may enhance the durability of the tool 2.

With respect to tool 62, it is contemplated that component parts (such as, for example, mounting bracket 63, retaining member 68 and foot member 70) may be adjustable and/or removable.

The number and location of apertures 8, 9, 13 will correspond to the number and location of lug bolts 26 on the hub bearing assembly 24. In one embodiment of tool 2, slots 13 are manufactured by drilling or punching two 5-point bolt holes 21 and two 4-point bolt holes 23 then joining one 5-point bolt hole 21 and one adjacent 4-point bolt hole 23 in a second process. The bolt holes within a set of bolt holes are equally spaced radially and angularly. In one embodiment, the central longitudinal axis 15 of one series (set) of the bolt holes dues not coincide with the central longitudinal axis 17 of another series (set) of bolt holes.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including such equivalent construction insofar as they do not depart from the spirit and scope of the conception regarded as the present invention.

I claim:

1. A hub bearing assembly removal tool comprising an elongated member having a mounting flange wherein the mounting flange is disposed at a first end of the elongated member and is outwardly protruding therefrom, and comprises two apertures that are configured to receive two lug bolts of a hub bearing assembly, and when the hub bearing assembly tool is secured to the hub bearing assembly with one or more mechanical fasteners, the elongated member provides sufficient leverage and converts a downward force to a torque sufficient to pry the hub bearing assembly from its seat.

2. The hub bearing assembly removal tool of claim 1, wherein the two apertures are disposed and configured to receive two lug bolts of
a standard 4 lug bolt hub assembly for a 2.3 inch hub, and
a standard 6 lug bolt hub assembly for a 3.25 inch hub, and
a standard 8 lug bolt hub assembly for a 4.75 inch hub, and
a standard 5 lug bolt hub assembly for a 2.875 inch hub.

3. The hub bearing assembly removal tool of claim 1, wherein the mounting flange further comprises a concave cutout having radial circumference of 1.6 inches at a centerpoint of the cutout along a peripheral edge of the concave wall.

4. A hub bearing assembly removal tool comprising an elongated member having a mounting flange, wherein
the mounting flange is disposed at a first end of the elongated member and is outwardly protruding therefrom,
the mounting flange comprises a first elongated aperture and a second elongated aperture linearly disposed along an axis that are each configured to receive a lug bolt of a hub bearing assembly such that the hub bearing assembly tool is secured to the hub bearing assembly with one or more mechanical fasteners affixed to the lug bolts, and
the mounting flange further comprises a concave cutout having radial circumference of 1.6 inches at a centerpoint of the cutout along a peripheral edge of the concave wall.

5. The hub bearing assembly removal tool of claim 4, wherein the first elongated aperture and the second elongated aperture each have an elongated slot width adapted to receive a pair of corresponding lug bolts of a mounting bolt pair, and an elongated slot length adapted to receive a plurality of hub bolt configurations of a hub bolt assembly.

6. The hub bearing assembly removal tool of claim 5, wherein the first elongated aperture and second elongated aperture are disposed and configured to receive two lug bolts of
a standard 4 lug bolt hub assembly for a 2.3 inch hub, and
a standard 6 lug bolt hub assembly for a 3.25 inch hub, and
a standard 8 lug bolt hub assembly for a 4.75 inch hub, and
a standard 5 lug bolt hub assembly for a 2.875 inch hub.

7. The hub bearing assembly removal tool of claim 5, wherein a length of the mounting flange at its longest point is 8 inches and a width of the mounting flange at its longest point is 5 inches.

8. A hub bearing assembly removal tool comprising:
a mounting flange having an elongated member perpendicularly attached to a lower portion of the mounting flange;
a pair of projecting supports symmetrically located about a centerline of the hub bearing assembly removal tool comprising a left projecting support having an inner left edge and a right projecting support having an inner right edge wherein the inner left edge and the inner right edge are connected via a concave cutout having radial circumference of 1.6 inches at a centerpoint of the cutout along a peripheral edge of the concave wall;
a pair of slots comprising a left slot and a right slot each disposed below the left projecting support and right projecting support respectively, the left and right slots each having an elongated slot width adapted to receive a pair of corresponding lug bolts of a mounting bolt pair, and an elongated slot length adapted to receive a plurality of hub bolt configurations of a hub bolt assembly, wherein placement of the pair of slots, the concave cutout, and the outer left edge and the outer right edge are configured such that the mounting flange does not receive interference from a neck of a hub bolt assembly, and the right outer edge and the left outer edge clear a plurality of nonengaged lug bolts when the pair of slots are affixed to a mounting bolt pair.

9. The hub bearing assembly removal tool of claim 8 wherein the projecting supports comprise a triangular shaped support.

10. The hub bearing assembly removal tool of claim 8 wherein the projecting supports comprise a semicircular shaped support.
